(19) United States
(12) Patent Application Publication
(10) Pub. No.: US 2026/0145576 A1
(43) Pub. Date: May 28, 2026

(54) CHARGE CONTROL VIA ON-VEHICLE INTERFACE

(71) Applicant: Textron Inc., Providence, RI (US)

(72) Inventors: Gregory August Theodosakis, Martinez, GA (US); Russell William King, Evans, GA (US); Kevin Douglas Grove, McCormick, SC (US)

(73) Assignee: Textron Inc., Providence, RI (US)

(21) Appl. No.: 18/956,331

(22) Filed: Nov. 22, 2024

(51) Int. Cl. B60L 58/14; B60L 53/62

(52) U.S. Cl. CPC B60L 58/14; B60L 53/62; B60L 2200/22

(57) ABSTRACT

A recreational vehicle system includes a recreational vehicle and a vehicle control system. The recreational vehicle includes a chassis, an electric motor, a plurality of tractive elements, at least one of the plurality of tractive elements is driven by the electric motor. The recreational vehicle includes battery system having a battery pack and a battery management system, and an operator interface. The vehicle control system configured to acquire a maximum SOC threshold and a reserve SOC threshold for the battery pack. The vehicle control system is configured to determine a current SOC of the battery pack and compare the current SOC of the battery pack to the maximum SOC threshold and the reserve SOC threshold and operate one or more components of the recreational vehicle responsive to the current SOC of the battery pack being below the reserve SOC threshold or above the maximum SOC threshold.

### BACKGROUND

The present disclosure relates generally to a control system for a vehicle. More specifically, the present application relates to a system for controlling the charge available to a user for a battery powered vehicle.

### SUMMARY

One embodiment relates to a recreational electric vehicle system. The recreational vehicle system includes a recreational vehicle and a vehicle control system. The recreational vehicle includes a chassis, an electric motor, a plurality of tractive elements, at least one of the plurality of tractive elements is driven by the electric motor. The recreational vehicle includes battery system having a battery pack and a battery management system, and an operator interface. The vehicle control system configured to acquire a maximum state of charge (SOC) threshold and a reserve SOC threshold for the battery pack. The vehicle control system is configured to determine a current SOC of the battery pack and compare the current SOC of the battery pack to the maximum SOC threshold and the reserve SOC threshold. The vehicle control system is configured to operate one or more components of the recreational vehicle responsive to the current SOC of the battery pack being below the reserve SOC threshold or above the maximum SOC threshold, the one or more components including the electric motor, the battery system, or the operator interface.

Another embodiment relates to a recreational vehicle system. The recreational system includes one or more processing circuits. The one or more processing circuits are configured to acquire an artificial state of charge (SOC) threshold and a reserve SOC threshold for a battery pack of a recreational vehicle, the artificial SOC threshold and the reserve SOC corresponding to a total SOC of the battery pack. The one or more processing circuits are configured to acquire sensor data indicative of a first SOC of the battery pack, compare the first SOC of the battery pack to the artificial SOC threshold, restrict operation of the golf vehicle responsive to determining that the first SOC is at or below the artificial SOC threshold, and receive a user input to activate a remaining SOC of the battery pack. The one or more processing circuits are configured to permit unrestricted operation of the golf vehicle in response to the user input, acquire sensor data indicative of a second SOC of the battery pack, compare the second SOC of the battery pack to the reserve SOC threshold, and instruct an operator of the recreational vehicle to return the recreational vehicle to a return location responsive to the determining that the second SOC is at or below the reserve SOC threshold.

Still another embodiment relates to a method. The method includes acquiring an artificial state of charge (SOC) threshold and a reserve SOC threshold for a battery pack of a recreational vehicle, the artificial SOC threshold and the reserve SOC corresponding to a total SOC of the battery pack. The method includes acquiring sensor data indicative of a first SOC of the battery pack, comparing the first SOC of the battery pack to the artificial SOC threshold, and restricting operation of the golf vehicle responsive to determining that the first SOC is at or below the artificial SOC threshold. The method includes receiving a user input to activate a remaining SOC of the battery pack, permitting unrestricted operation of the golf vehicle in response to the user input, acquiring sensor data indicative of a second SOC of the battery pack, comparing the second SOC of the battery pack to the reserve SOC threshold, and instructing an operator of the recreational vehicle to return the recreational vehicle to a return location responsive to the determining that the second SOC is at or below the reserve SOC threshold.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a fleet monitoring and control system including a plurality of the vehicles of FIG. 1, according to an exemplary embodiment.

FIG. 5 is a flow diagram of a process for monitoring state of charge (“SOC”) of a battery module of the vehicle of FIG. 1, according to an exemplary embodiment.

FIGS. 6A and 6B are flow diagrams of a process for setting and moderating artificial SOC thresholds and reserve SOC thresholds, according to an exemplary embodiment.

FIG. 7 is a flow diagram of a process for generating recommendations based on SOC usage trends, according to an exemplary embodiment.

FIG. 8 is a graphical user interface showing a provider dashboard, according to an exemplary embodiment.

FIGS. 9A and 9B are a graphical user interface showing an operator dashboard, according to exemplary embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

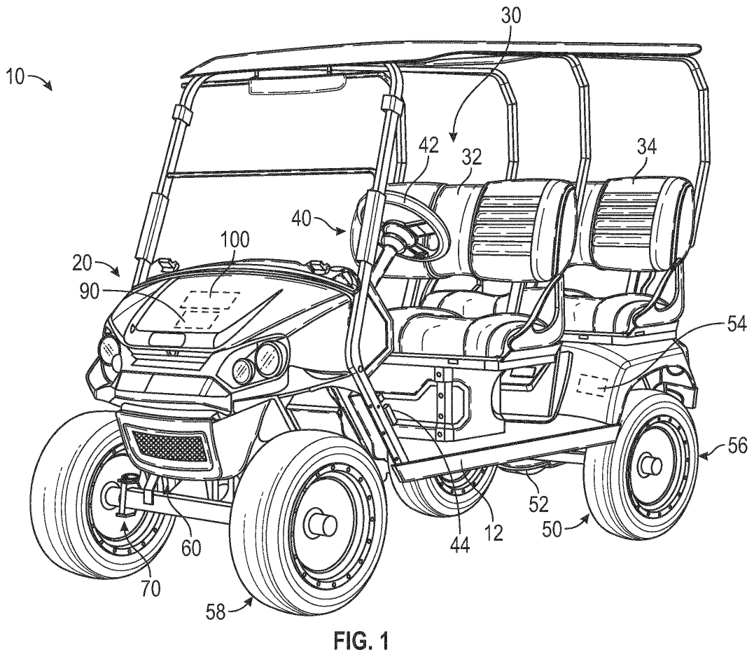

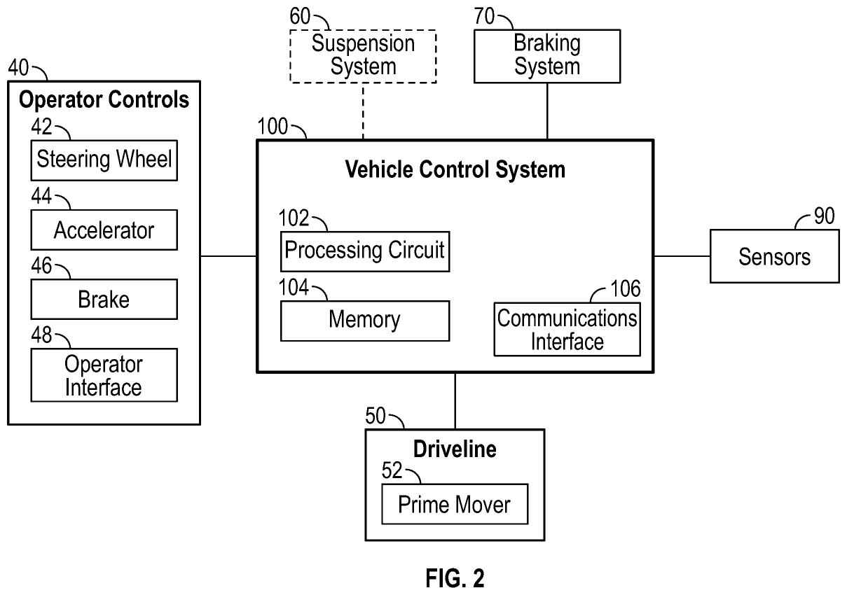

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

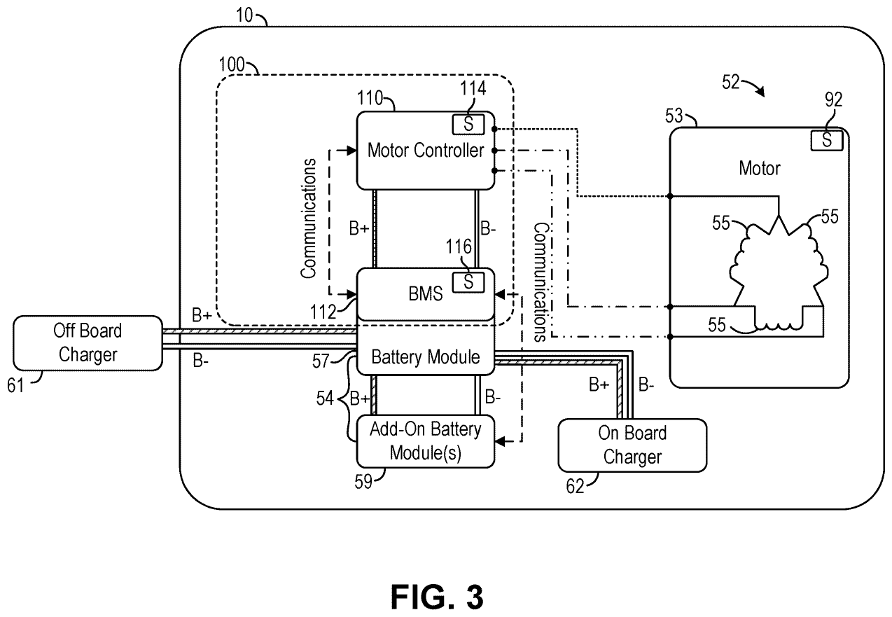

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92 (e.g., an encoder, a speed sensor, etc.); (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

According to an exemplary embodiment, the battery module 57 may be electrically coupled to one or more chargers, shown as on board charger 62 and off board charger 61, to facilitate charging of the battery system. The on board charger 62 directs energy generated during regenerative braking events to the battery module 57. When the brakes are applied, the motor 53 may act as a generator, converting kinetic energy into electrical energy, which the motor controller 110 directs (e.g., converts from AC to DC and provides) back to the battery system. The off board charger 61 is a charger that is external to the vehicle 10 and includes power electronics to convert AC power from an external source to DC power that can be used to charge the battery system. In some embodiments, the on board charger 62 performs the functions of the off board charger 61 such that the off board charger 61 is not needed.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

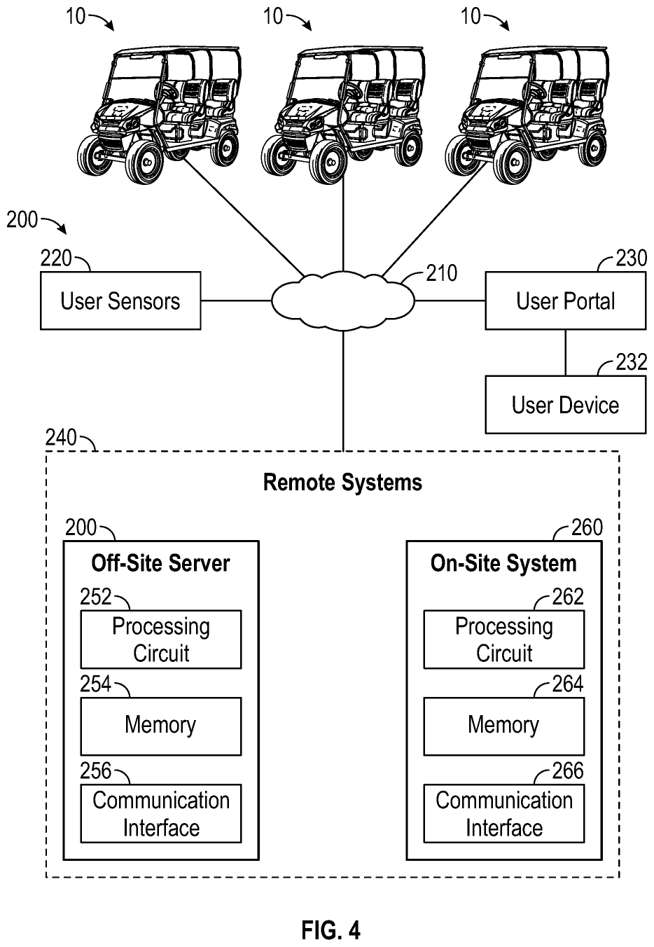

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

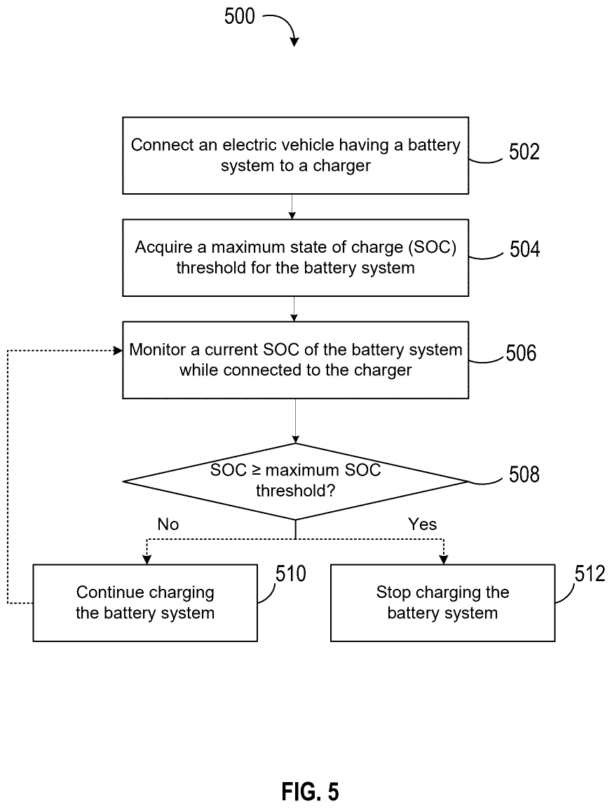

Referring to FIG. 5, a flow diagram of a process 500 for monitoring the SOC of the battery module 57 and the add-on module(s) 59 of the battery system is shown, according to an exemplary embodiment. The process 500 may be performed by the vehicle control system 100 and/or the BMS 112.

At step 502, the vehicle 10 is connected to a charger (e.g., plugged into a charger, in proximity for induction charging, etc.). AC Power is provided to the on board charger 62 or off board charger 61 through connection to a power utility. The on board charger 62 or the off board charger 61 then converts the AC power to DC power for storage in the battery system.

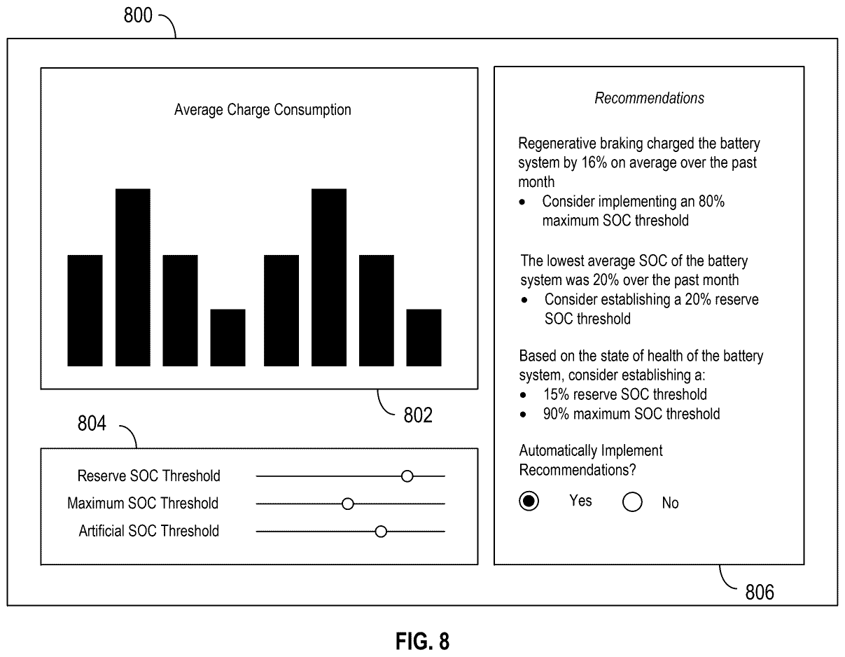

At step 504, the vehicle control system 100 and/or the BMS 112 are configured to acquire a maximum SOC for the battery system. The maximum SOC may be input by a user on an interface (e.g., the GUI 800 of FIG. 8) in terms of percentage. By way of example, a provider of the vehicle 10 (e.g., golf course management, a rental company, etc.) may set the maximum SOC via the user portal 230 and the user device 232. In this case, the user portal 230 allows the vehicle provider to control how much the battery system is charged (e.g., based on scheduled rentals, to prevent overcharging, etc.). For example, if a vehicle 10 is not rented for a day, then the vehicle provider may set a 90% maximum SOC to prevent overcharging of the battery system (e.g., during regenerative braking events). Conversely, if a vehicle 10 is rented for a day, or is scheduled for multiple rentals in a day, then the vehicle provider may set the maximum SOC at 100% to ensure the vehicle 10 is available and charged for its scheduled rentals. In other examples, the vehicle control system 100 and/or the BMS 112 may generate a maximum SOC value based on SOC usage trends. For example, if the vehicle control system 100 and/or the BMS 112 detects that a vehicle 10 is typically used for short distances (e.g., half day rentals, 8 hole golf rounds, etc.) during each deployment, it might adjust the SOC limit to 70% rather than 100% to reduce wear on the battery system. Similarly, the vehicle control system 100 and/or the BMS 112 could calculate the maximum SOC using sensor data indicative of the age, health, or operating conditions of the battery module 57 and/or the add-on battery module(s) 59. If the vehicle control system 100 and/or the BMS 112 detects that a battery module 57 is above a threshold age and operating above a threshold temperature, it may automatically reduce the maximum SOC (e.g., to 80%) to mitigate the risk of overheating and prolong battery life. Conversely, for newer batteries (e.g., below the threshold age) operating in cooler environments (e.g., below the threshold temperature), the system may allow a higher maximum SOC (e.g., 95% 100%).

At step 506, the vehicle control system 100 and/or the BMS 112 monitor a current SOC of the battery system while the on board charger 62 and/or the off board charger 61 are coupled to the charger and receiving power therefrom. By way of example, the BMS sensor 116 may continuously measure and transmit data regarding the battery module 57 (e.g., temperature, voltage, current, speed, SOC, rate of charge, rate of discharge, etc.) to the BMS 112 and/or the vehicle control system 100. In some examples, the BMS 112 and/or the vehicle control system 100 calculate the SOC based on the data transmitted from the BMS sensor 116. In other examples, the BMS sensor 116 may directly measure or calculate the SOC of the battery system and may transmit the SOC to the BMS 112 and/or the vehicle control system 100.

At step 508, the vehicle control system 100 and/or the BMS 112 determine whether the current SOC of the battery system is at or exceeds the maximum SOC threshold. If the current SOC exceeds or meets the maximum SOC threshold, the vehicle control system 100 and/or the BMS 112 proceed to step 512 and stop charging the battery system. By way of example, when the charger is connected to the on board charger 62, the BMS 112 may send a signal to the on board charger 62 to stop the flow of current into the battery module 57. In other examples, the BMS 112 might disconnect a physical connection between the on board charger 62 and the battery module 57 to cut off the electrical pathway between the on board charger 62 and the battery module 57(e.g., by operating a relay or switch). When connected to an off board charger 61, the BMS 112 may send a signal to the external charging station or inhibit current from flowing into the vehicle 10 (e.g., by sending a stop-charging command via CAN bus protocol). Conversely, if the current SOC of the battery system falls below the maximum SOC threshold, the vehicle control system 100 and/or BMS 112 proceed to step 510 and continue charging the battery system (e.g., by maintaining connection with the on board charger 62 and/or the off board charger 61).

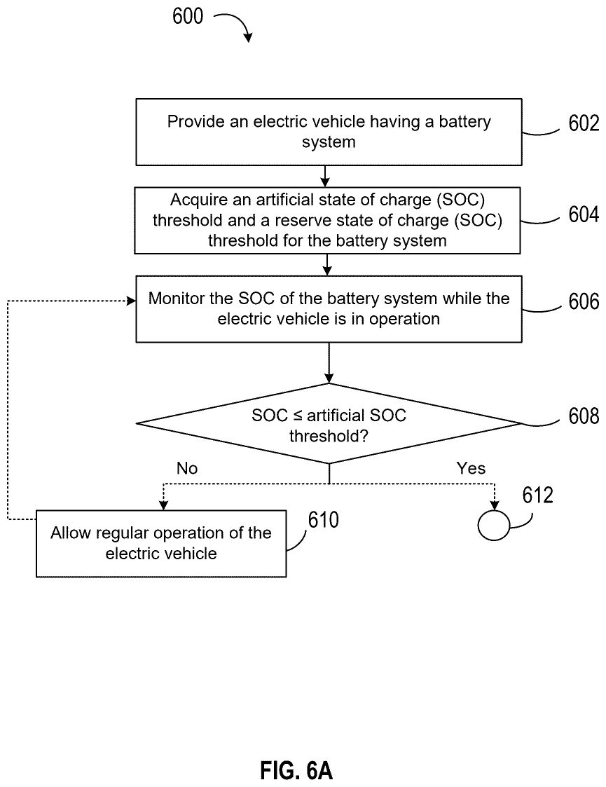

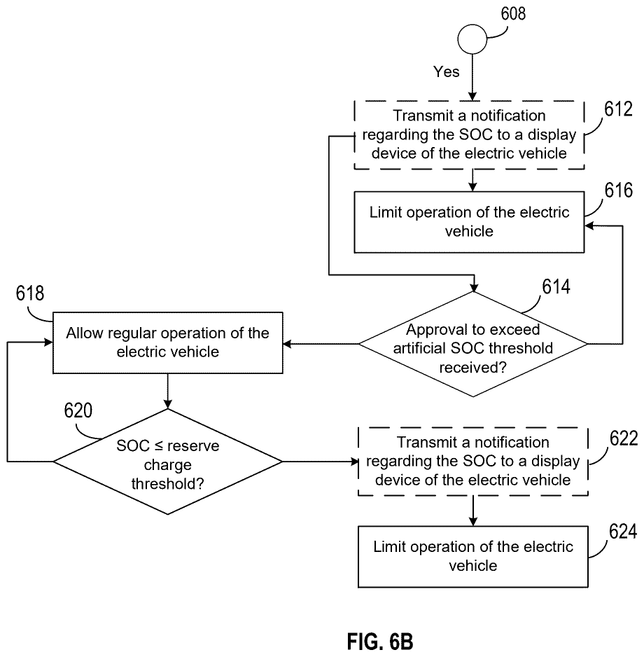

Referring now to FIGS. 6A and 6B, a flow diagram of a process 600 for setting and moderating (e.g., modulating, adjusting, limiting, etc.) artificial SOC thresholds and reserve SOC thresholds is shown, according to an exemplary embodiment. The process 600 may be performed by the vehicle control system 100, the BMS 112, and/or the remote systems 240.

At step 602, a user is provided with a vehicle 10 having a battery system (e.g., the BMS 112, the battery module 57, the add-on battery module(s) 59, etc.). Although described as an electric vehicle, it should be understood that the process 600 may apply to a hybrid vehicle system including a combustion engine, or fuel cell, in addition to a battery system. In other examples, the process 600 may apply to a combustion engine.

At step 604, the vehicle control system 100 and/or the BMS 112 acquires an artificial SOC threshold and a reserve SOC threshold for the battery system. The reserve SOC threshold and the artificial SOC threshold refer to a set of threshold capacities, below which, normal operation of the vehicle 10 may be limited. For example, the reserve SOC threshold and the artificial SOC threshold may serve to conserve enough charge to allow a vehicle 10 to return to a charging station at an end of a rental period. The artificial SOC threshold represents an intermediate point between the battery system's total capacity and the reserve threshold. For example, the artificial SOC threshold may be set to 50% of the total SOC of the battery system, whereas the reserve SOC threshold may be set to 10% of the total SOC of the battery system.

The artificial SOC threshold and the reserve SOC threshold may be input by a user on an interface (e.g., the GUI 800 of FIG. 8) as a fixed value, such as a specific percentage of the battery system's capacity, or an allotted rental time. By way of example, a provider of the vehicle 10 (e.g., golf course management, a rental company, etc.) may set the artificial SOC threshold and the reserve SOC threshold via the user portal 230. In other examples, the vehicle control system 100, the BMS 112, and/or the remote systems 240 may generate the artificial SOC threshold and the reserve SOC threshold based on, for example, a schedule of vehicle 10 rentals. For example, if a vehicle 10 is booked for two half-day rentals (e.g., each lasting approximately 4 to 6 hours), the vehicle control system 100, the BMS 112, and/or the remote systems 240 may set the artificial SOC threshold to 60% to allocate sufficient battery life for each rental and return. In this example, the vehicle control system 100, the BMS 112, and/or the remote systems 240 might also establish a reserve SOC threshold of 10% to ensure that there is enough charge left in the battery system for the vehicle 10 to complete its return (e.g., to a charging station, to a clubhouse, to a drop-off location, etc.).

In some examples, the artificial SOC threshold and the reserve SOC threshold are dynamic thresholds that are adjusted based on factors like, for example, the vehicle's current distance from a return location. For example, if a vehicle is far from a return point (e.g., a drop-off location, clubhouse, charging station, etc.), the system might set the artificial SOC threshold higher (e.g., 60%) to allocate enough power for the vehicle 10 to return to the return point. As the vehicle 10 gets closer to the return location, the threshold may be lowered to allow for more usage (e.g., 50%). Similarly, the reserve threshold can be dynamically adjusted (e.g., based on distance from a drop-off point, terrain, time remaining in a rental period, etc.). For example, if the vehicle 10 is far from the return location, the reserve threshold might be set at 15%, but if it is closer, the reserve SOC threshold may be set to 5%.

At step 606, the vehicle control system 100, the BMS 112, and/or the remote systems 240 monitor the SOC of the battery system while the vehicle 10 is in operation. By way of example, the BMS sensor 116 may continuously measure and transmit data regarding the battery module 57 (e.g., temperature, voltage, current, speed, SOC, rate of charge, rate of discharge, etc.) to the BMS 112, the vehicle control system 100, and/or the remote systems 240. In some examples, the BMS 112, the vehicle control system 100, and/or the remote systems 240 calculate the SOC of the battery system based on the data transmitted from the BMS sensor 116. In other examples, the BMS sensor 116 may directly measure or calculate the SOC of the battery system and may transmit the SOC to the BMS 112, the vehicle control system 100, and/or the remote systems 240.

At step 608, the vehicle control system 100 and/or the BMS 112 compares the current SOC of the battery system to the artificial SOC threshold. If the current SOC is greater than the artificial SOC threshold, then the vehicle control system 100, the BMS 112, and/or the remote systems 240 proceed to step 610 and allow regular/normal operation of the vehicle 10 (e.g., performance of the vehicle 10 is not limited in any way, no warnings are provided to the operator, etc.). The vehicle control system 100, the BMS 112, and/or the remote systems 240 continue to monitor the current SOC of the battery system and allowing regular operation of the vehicle 10 until the current SOC of the battery system falls below or reaches the artificial SOC threshold. Responsive to the current SOC of the battery system falling below or reaching a value equivalent to the artificial SOC threshold, the vehicle control system 100, the BMS 112, and/or the remote systems 240 may proceed to optional step 612.

At optional step 612, the vehicle control system 100, the BMS 112, and/or the remote systems 240 transmit a notification regarding the current SOC to a display device of the vehicle 10 (e.g., the operator interface 48) and/or a personal device of the operator of the vehicle 10 (e.g., the user device 232). The notification may be, for example, a graphical representation of the current SOC value, what action should be taken, and/or what limitation may be imposed if the action is not taken. The vehicle control system 100 and/or the BMS 112 may operate an alarm (e.g., an audial alarm, vibrations, flashes, etc.) as part of the notification. In some embodiments, the vehicle control system 100, BMS 112, the remote systems 240 perform an action that is unique to and based on the current SOC value relative to the artificial SOC threshold. In other embodiments, the vehicle control system 100, the BMS 112, and/or the remote systems 240 perform a single action regardless of how far the current SOC value is below the artificial SOC threshold. In some examples, the vehicle control system 100, the BMS 112, and/or the remote systems 240 proceed to step 614 from optional step 612. In other examples, the vehicle control system 100 and/or the BMS 112 proceed to step 616 from optional step 612.

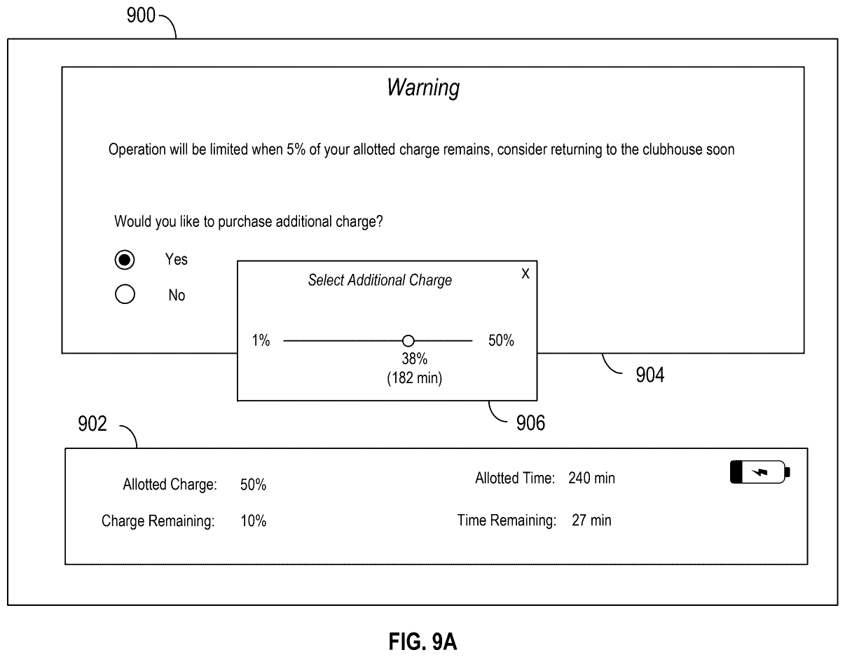

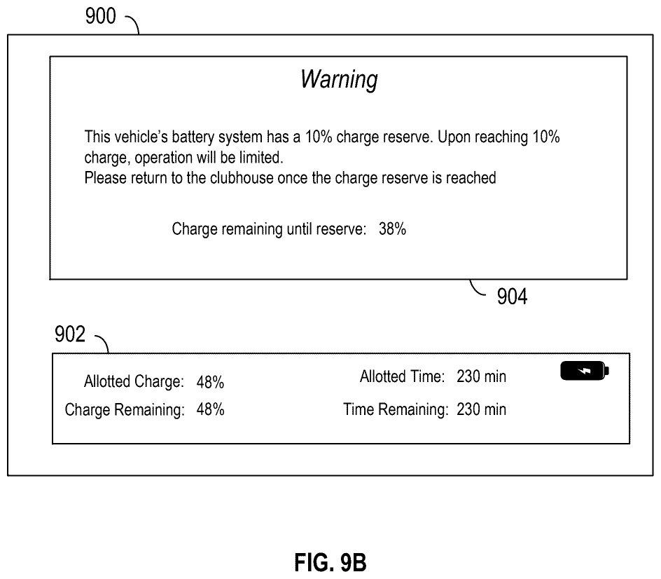

In some examples, the notification regarding the current SOC of the battery system may display a user interface on a display device of the vehicle 10 (e.g., the operator interface 48) that prompts the user with an option to activate (e.g., approve, purchase, etc.) additional access to the remaining SOC. The user interface may further include an inquiry asking whether the user would like to extend the use of the vehicle 10 by accessing more of the battery's capacity. The user interface may provide user-selectable options, allowing the user to choose how much additional SOC to add (e.g., selecting a specific percentage of the remaining battery capacity, extending the rental period by adding more time, etc.) (see, FIG. 9A). For example, if the battery system's SOC reaches the artificial threshold, the operator of the vehicle 10 may be prompted with a graphical user interface offering the option to extend their rental. The user could choose to access an additional percentage of the remaining SOC, or they could opt to add extra time to their rental. Alternatively, the user could choose to decline to access additional SOC, prompting the vehicle control system 100, the BMS 112, and/or the remote systems to proceed to step 616 and limit operation of the vehicle 10.

At step 614, the vehicle control system 100 and/or the BMS 112 receive an input regarding whether a user is approved to exceed the artificial SOC threshold. The input may be transmitted by the provider of the vehicle 10 (e.g., golf course management, a rental company, etc.) via the user portal 230. In this way, the provider may approve or deny additional use of the vehicle 10 remotely (e.g., in a clubhouse of a golf course, on the golf course, etc.). Additionally or alternatively, the input may be transmitted by the operator interface 48 responsive to a user/operator making an input choosing whether or not to access additional charge or rental time at step 612.

If the user does not have approval to exceed the artificial SOC threshold (e.g., by declining access to additional SOC/time, denial by the provider of the vehicle 10, etc.), then the vehicle control system 100, the BMS 112, and/or the remote systems 240 proceed to step 616 and limit operation of the vehicle 10. If the user has approval to exceed the artificial SOC threshold (e.g., by purchasing additional SOC/time, approval by the provider of the vehicle 10, etc.), then the vehicle control system 100, the BMS 112, and/or the remote systems 240 proceed to step 618, allowing regular/normal operation of the vehicle 10 (e.g., performance of the vehicle 10 is not limited in any way, no warnings are provided to the operator, etc.). The vehicle control system 100, the BMS 112, and/or the remote systems 240 continue to monitor the current SOC of the battery system and allow regular operation of the vehicle 10 until the current SOC of the battery system falls below or is equivalent to the reserve SOC threshold. Responsive to the current SOC of the battery system falling below or to a value equivalent to the reserve SOC threshold, the vehicle control system 100, the BMS 112, and/or the remote systems 240 proceed to step 620.

At step 616, the vehicle control system 100, the BMS 112, and/or the remote systems 240 impose operational limits on the vehicle 10 when the current SOC falls below the artificial SOC threshold. For example, the vehicle control system 100, the BMS 112, and/or the remote systems 240 may limit the speed of the vehicle 10 to a reduced speed or completely prevent it from moving (e.g., 5 mph, by engaging the braking system 70, by preventing operation of the prime mover 52). In some examples, operations of the vehicle 10 are limited until the operator of the vehicle 10 performs a specific action, such as beginning to return the vehicle 10 to a return point (e.g., a charging station or drop-off point). Once the vehicle control system 100, the BMS 112, and/or the remote systems 240 detect that the operator is taking steps to return the vehicle 10 (e.g., using GPS data, a position sensor, etc.), the vehicle control system 100, the BMS 112, and/or the remote systems 240 may relax the operational limits, allowing the vehicle 10 to move at a normal or less restricted speed (e.g., 10-15 mph) while heading towards the return point.

At step 620, the vehicle control system 100, the BMS 112, and/or the remote systems 240 compares the current SOC of the battery system to the reserve SOC threshold. If the current SOC is greater than the reserve SOC threshold, then the vehicle control system 100 and/or the BMS 112 proceed to step 618 and allow regular/normal operation of the vehicle 10. The vehicle control system 100, the BMS 112, and/or the remote systems 240 continue to monitor the current SOC of the battery system and allow regular operation of the vehicle 10 until the current SOC of the battery system falls below or is equivalent to the reserve SOC threshold. Responsive to the current SOC of the battery system falling below or reaching a value equivalent to the reserve SOC threshold, the vehicle control system 100, the BMS 112, and/or the remote systems 240 may proceed to optional step 622.

At optional step 622, the vehicle control system 100, the BMS 112, and/or the remote systems 240 transmit a notification regarding the current SOC to a display device of the vehicle 10 (e.g., the operator interface 48) or a user device 232 of the operator. The notification may be, for example, a graphical representation of the current SOC value, what action should be taken, and/or what limitation may be imposed if the action is not taken. The vehicle control system 100 and/or the BMS 112 may operate an alarm (e.g., an audial alarm, vibrations, flashes, etc.) as part of the notification. In some embodiments, the vehicle control system 100, the BMS 112, and/or the remote systems 240 perform an action that is unique to and based on the current SOC value relative to the reserve SOC threshold. In other embodiments, the vehicle control system 100, the BMS 112, and/or the remote systems 240 perform a single action regardless of how far the current SOC value is below the reserve SOC threshold.

At step 624, the vehicle control system 100, the BMS 112, and/or the remote systems 240 impose operational limits on the vehicle 10 when the current SOC falls below the reserve SOC threshold. For example, the vehicle control system 100, the BMS 112, and/or the remote systems 240 may limit the speed of the vehicle 10 to a reduced speed or completely prevent it from moving (e.g., 5 mph, by engaging the braking system 70, by preventing operation of the prime mover 52). In some examples, operations of the vehicle 10 are limited until the operator of the vehicle 10 performs a specific action, such as beginning to return the vehicle 10 to a return point (e.g., a charging station or drop-off point). Once the vehicle control system 100, the BMS 112, and/or the remote systems 240 detects that the operator is taking steps to return the vehicle 10 (e.g., using GPS data, a position sensor, etc.), the vehicle control system 100, the BMS 112, and/or the remote systems 240 may relax the operational limits, allowing the vehicle 10 to move at a normal or less restricted speed (e.g., 10-15 mph) while heading towards the return point. In some examples, the vehicle control system 100, the BMS 112, and/or the remote systems 240 may also engage regenerative braking as an operational limit when the current SOC falls below the reserve threshold. Regenerative braking allows the vehicle 10 to recover some energy during deceleration or while traveling downhill, which can be converted back into charge for the battery system. For example, when the operator begins returning the vehicle 10 to a return point (e.g., a charging station, a drop off area, the clubhouse, etc.), the vehicle control system 100 and/or the BMS 112 may activate regenerative braking automatically during deceleration to recuperate charge and extend the available driving range.

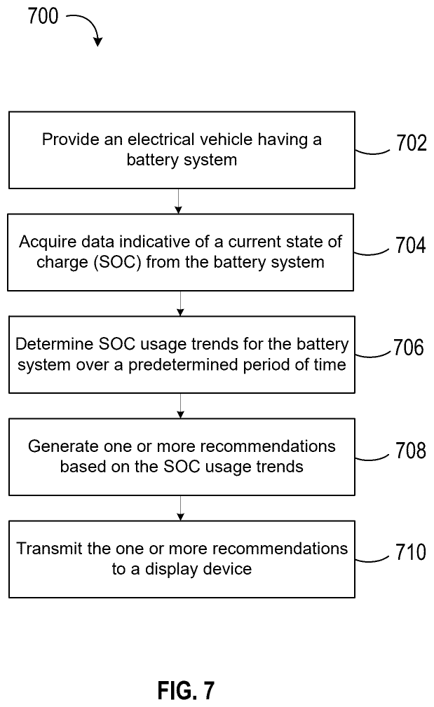

Referring to FIG. 7, a flow diagram of a process 700 for generating recommendations based on SOC usage trends is shown, according to an exemplary embodiment. The process 700 may be performed by the vehicle control system 100, the BMS 112, and/or the remote systems 240.

At step 702, a user is provided with an electrical vehicle (e.g., the vehicle 10) having a battery system (e.g., the battery module 57, the add-on battery module(s) 59, etc.). Although described as an electric vehicle, it should be understood that the process 700 may apply to combustion engine, fuel cell, or hybrid vehicle systems.

At step 704, the vehicle control system 100, the BMS 112, and/or the remote systems 240 regularly acquire data indicative of the current SOC of the battery system (e.g., continuously, every minute, every 5 minutes, hourly, etc.). For example, the BMS 112 may be configured to monitor characteristics of the rows and/or groups of battery cells and/or individual cells of the battery module 57 and the add-on battery module(s) 59 (e.g., using data acquired by the BMS sensor 116) such as voltage, temperature, current, and SOC. Additionally or alternatively, the vehicle control system 100 and/or the remote systems 240 may be configured to receive/acquire data acquired by the BMS sensor 116 (e.g., voltage, temperature, current, and SOC).

At step 706, the vehicle control system 100, the BMS 112, and/or the remote systems 240 determine SOC usage trends over a predetermined period of time (e.g., daily, weekly, monthly, yearly, all time, etc.). The SOC trend analysis may be performed by aggregating historical data collected by or transmitted to the BMS 112, the vehicle control system 100, and/or the remote systems 240. For example, the BMS 112 and/or the vehicle control system 100 may track the average charge consumption per trip, the SOC drop per hour of usage, and/or SOC levels after charging events. The vehicle control system 100, BMS 112, and/or the remote systems 240 may use this information to generate reports or notifications that are displayed to the user (e.g., via an operator interface 48), the provider (e.g., via user portal 230), and/or are transmitted to a remote server (e.g., the off-site server 250) for fleet management purposes.

At step 708, the vehicle control system 100, the BMS 112, and/or the remote systems 240 may analyze patterns in the battery system's SOC, including data on charging habits, regenerative braking events, and overall SOC levels to generate one or more recommendations for the user. For example, the control logic may detect recurring instances of high regenerative current when the SOC is high (e.g., 90-100%), which could pose a risk to battery longevity. In such cases, the vehicle control system 100 and/or the BMS 112 may display a notification (e.g., via the operator interface 48, the user device 232, etc.) advising the user to consider reducing the maximum SOC for charging to mitigate the risk of high regenerative current (e.g., reducing the charge to 80%). The control logic of the vehicle control system 100, the BMS 112, and/or the remote systems 240 may also track how frequently the battery system is fully charged and discharged over time. For example, if the vehicle control system 100, the BMS 112, and/or the remote systems 240 observe that the SOC rarely dropped below 25% over the past 30 days, a recommendation could be displayed to the user suggesting that a maximum SOC capacity be established. For example, the system may initially suggest lowering the maximum charge to 95%. If the discharge pattern persists (e.g., for another 30 days), the control logic may further recommend a gradual reduction to 90%. The vehicle control system 100, the BMS 112, and/or the remote systems 240 may also analyze usage patterns and recommend adjusting the maximum SOC threshold to reflect typical SOC usage. For example, if the vehicle 10 is generally used for short trips that consume a small portion of the SOC (e.g., less than 50%), the system may suggest reducing the maximum SOC threshold to avoid overcharging. As another example, the vehicle control system 100, the BMS 112, and/or the remote systems 240 may calculate an average amount of power/charge generated from regenerative braking over a predetermined period of time. Based on the average amount of power/charge generated by regenerative braking, the vehicle control system 100, the BMS 112, and/or the remote systems 240 may recommend a reduced maximum SOC threshold. For example, if the battery system is recharged by 16% from regenerative braking on average, the vehicle control system 100 and/or the BMS 112 may recommend a 85% maximum SOC threshold to accommodate for the regenerative braking.

Similarly, if the vehicle control system 100, the BMS 112, and/or the remote systems 240 determine that the SOC rarely drops below a certain level (e.g., 25%), it may recommend establishing a reserve SOC threshold (e.g., as illustrated in FIG. 8). Setting a reserve SOC threshold would allow the vehicle 10 to retain charge and avoid unnecessary depletion during operation. The vehicle control system 100, the BMS 112, and/or the remote systems 240 may also modify the recommendations in response to environmental conditions, such as extreme temperatures. For example, in colder temperatures, the vehicle control system 100, the BMS 112, and/or the remote systems 240 may automatically recommend that the user maintain a higher reserve SOC threshold so that the battery system retains enough charge to operate effectively in lower temperatures.

At step 710 the vehicle control system 100, the BMS 112, and/or the remote systems 240 may transmit to and/or cause a display device (e.g., via the operator interface 48, the user device 232, etc.) to display a user interface having one or more of the recommendations generated at step 708. For example, the recommendation may read “Consider setting a maximum charge threshold to 70% based on your usage patterns to preserve battery health.” The user interface may present user-selectable elements, allowing the user to choose how to respond to the recommendation. For example, the interface may include options like “yes” or “no” for the user to approve or reject implementing the recommended maximum SOC threshold. In some examples, a user may select an option to automatically implement all or some of the recommended threshold adjustments. For example, a user may choose to automatically implement recommended reserve threshold adjustments but may continue to manually control the maximum SOC threshold. Examples of the user interfaces generated by the vehicle control system 100, the BMS 112, and/or the remote systems 240 are described in greater detail with reference to FIGS. 8-9B.

Referring to FIG. 8, a first graphical user interface (“GUI”), shown as GUI 800, of a provider dashboard is shown, according to an exemplary embodiment. The GUI 800 may be displayed for a provider (e.g., golf course management, a rental company, etc.) via the user portal 230. The GUI 800 may be displayed on the user device 232, and/or on the operator interface 48. The GUI 800 is shown to include an average charge consumption widget 802, a threshold adjustment widget 804, and a recommendations widget 806. In various embodiments, the GUI 800 may display some or all of the widgets 802, 804, 806 shown, and the GUI 800 may also include additional or alternative widgets depending on specific use cases or system configurations.

The average charge consumption widget 802 is shown to include a graphical depiction of the amount of charge consumed by the battery system within a predetermined period (e.g., daily, weekly, monthly, etc.). For example, the average charge consumption widget 802 may present the percentage of charge used (e.g., hourly, daily, weekly, etc.), represented as a numerical value, or a graphical gauge. The average charge consumption widget 802 may display historical data comparisons of current charge consumption trends against previous periods. In some examples, the average charge consumption widget 802 displays an aggregated average charge consumption value for a selected time frame (e.g., the past week, past month, and/or past year). The average charge consumption may include additional information regarding the maximum charge (e.g., what the battery system was charged up to) and minimum charge (e.g., the SOC at the time the battery system connects to a charging source). In some examples, the average charge consumption widget 802 includes details on charging sessions, such as each charging session's duration, the SOC before and after charging, and/or any associated costs.

The threshold adjustment widget 804 is shown to include interactive/adjustable sliders for setting the reserve SOC threshold, the maximum SOC threshold, and the artificial SOC threshold. The threshold adjustment widget 804 may display sliders or other input fields where users can manually adjust SOC thresholds (e.g., changing the maximum charge threshold from 80% to 70% to optimize battery health). By way of example, the sliders may be set to move by increments of 1%. In this way, the user may move the slider along the slide bar to adjust the threshold values within single percentage values. The widget may also include automated options, enabling a user to choose preset threshold values based on recommendations from the vehicle control system 100, BMS 112, and/or the remote systems 240. In various embodiments, the threshold adjustment widget 804 may display some or all of the sliders shown, and the threshold adjustment widget 804 may also include additional or alternative sliders depending on specific use cases or system configurations. For example, if a vehicle 10 is owned by an individual for personal use (e.g., not rented to other users), the artificial SOC threshold slider may not be included in the threshold adjustment widget 804.

The recommendations widget 806 is shown to include the recommendations generated by the vehicle control system 100, the BMS 112, and/or the remote systems 240 (e.g., at step 708 of FIG. 7). The recommendations widget 806 resents the personalized suggestions generated by the vehicle control system 100, the BMS 112, and/or the remote systems 240 based on battery usage patterns, environmental conditions, and other relevant operational data. The recommendations widget 806 may be updated at regular intervals (e.g., daily, weekly, etc.) or may be updated continuously as new recommendations are generated. In some examples, the recommendations widget 806 includes a user selectable option/input field to automatically implement recommendations. If the user chooses to automatically implement the generated recommendations, the vehicle control system 100 and/or the BMS 112 may operate various components of the vehicle 10 to apply the recommendations. For example, if the SOC exceeds or meets the recommended maximum SOC threshold, the vehicle control system and/or the BMS 112 may stop charging the battery module 57 (e.g., by sending a signal to the on board charger 62 to stop the flow of current into the battery module 57, disconnecting a physical connection between the on board charger 62 and the battery module 57, etc.).

Referring to FIGS. 9A and 9B, a second GUI, shown as GUI 900 of a user/operator dashboard is shown, according to exemplary embodiments. The GUI 900 may be displayed for an operator of the vehicle 10 via the operator interface 48 and/or a user device associated with the operator. The GUI 900 may be generated by the vehicle control system 100, the BMS 112, and/or the remote systems 240 (e.g., at step 612 of FIG. 6B). The GUI 900 is shown to include a charge status widget 902, a warning widget 904, and an additional charge selection widget 906. In various embodiments, the GUI 900 may display some or all of the widgets 902, 904, 906 shown, and the GUI 900 may also include additional or alternative widgets depending on specific use cases or system configurations.

The charge status widget 902 is shown to include an allotted charge percentage and a charge remaining percentage. The allotted charge percentage represents the amount of charge a user has access to (e.g., from a rental purchase). Additionally or alternatively, the charge status widget 902 may include an allotted time. The allotted time may be an estimate based on the allotted charge (e.g., as a projection of the minutes of charge available based on current use). Alternatively, the allotted time may represent the duration a user has access to (e.g., from a rental purchase), while the allotted charge percentage is an estimate derived from this allotted time (e.g., a projection of the percentage of charge based on the available duration).

In some examples, the charge status widget 902 includes an icon (e.g., a battery, a gauge, etc.) that visually represents the user's remaining allotted charge as a fraction of the total charge allocated to them, rather than as a percentage of the battery system's full SOC. In other words, the icon reflects the remaining charge relative to the artificial SOC threshold, displaying only the portion of the battery available to the user based on their allotted charge. In this way, the icon may display a low battery symbol based on the artificial threshold, even when the battery system has a significant amount of remaining charge (e.g., 30-60%).

The warning widget 904 is shown to include a notification regarding the SOC approaching either the artificial SOC threshold or the reserve SOC threshold. In some examples, the only widget shown on the GUI 900 is the charge status widget 902 until certain operational conditions are met by the vehicle 10. For example, the warning widget 904 may be added to the GUI 900 responsive to the SOC approaching the artificial SOC threshold or the reserve SOC threshold. In other examples, the warning widget 904 may include a fixed warning regarding what limitation will be imposed when the vehicle 10 reaches the artificial SOC threshold or the reserve SOC threshold. In some examples, the warning widget 904 includes a graphical representation of what action should be taken upon reaching a threshold charge, and/or what limitation may be imposed if the action is not taken. For example, the warning widget 904 may display “You have reached your allotted charge, vehicle speed will be limited to 3 mph until you begin proceeding in the direction of the clubhouse.”

The warning widget 904 may include a user selectable option to access or purchase additional charge or rental time. In some examples, if a user selects “yes” or another affirmative input to purchasing additional charge or rental time, the vehicle control system 100, the BMS 112, and/or the remote systems 240 update the GUI 900 to display the additional charge selection widget 906 (e.g., as a dashboard widget, as a pop-up window, as a new interface screen, etc.).

The additional charge selection widget 906 may display a slider or other input fields where users can manually increase their allotted charge or allotted time. The slider may be set to move by a preset minimum increment (e.g., 1%, 5%, 10%, 10-30 minutes, 1 hour etc.). In this way, the provider may set a minimum increment of increase for added time or charge to a rental. The additional charge selection widget 906 may also display dynamic pricing information. For example, as users adjust their allotted charge or time, the corresponding cost may automatically update. The additional charge selection widget 906 may be integrated with the vehicle's operational data, for example, to show estimates of how the added charge or time will impact vehicle range or performance. For example, after selecting an additional 10% charge, the additional charge selection widget 906 may display a message like “Estimated range increased by 15 miles.”

If a user chooses to add additional charge to their allotted charge, the GUI 900 may update the widgets 902, 904 according to the user's selections. The charge status widget 902 may also be updated to display the new allotted charge and allotted time. The warning widget 904, for example, may be updated to display the reserve charge threshold (e.g., 10%). In other examples, the warning widget 904 may include a fixed warning regarding what limitation will be imposed when the vehicle 10 reaches the reserve SOC threshold. In some examples, the warning widget 904 includes a graphical representation of what action should be taken upon reaching the reserve threshold charge, and/or what limitation may be imposed if the action is not taken. For example, the warning widget 904 may display “You have reached the charge reserve, vehicle speed will be limited to 3 mph until you begin proceeding in the direction of the clubhouse.” In some examples, the warning widget 904 may include a countdown of the estimated charge or time remaining until the user will reach the charge reserve (e.g., the charge below the reserve SOC threshold).

In some examples, the charge status widget 902 updates the icon (e.g., a battery, a gauge, etc.) that visually represents the user's remaining allotted charge as a fraction of the total charge allocated to them (e.g., rather than as a percentage of the battery system's full SOC). In other words, the icon reflects the remaining charge relative to the user's total allotted charge rather than relative to the total SOC of battery (e.g., displaying only the portion of the battery's charge available to the user). In this way, when a user adds additional charge or time, the icon may update to reflect a full battery, even if the system's overall SOC remains significantly lower than the total capacity (e.g., displaying full charge for 48% remaining/48% allocated rather than 48% remaining/100% total SOC).

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A recreational electric vehicle system comprising:
a recreational vehicle including:
a chassis;
an electric motor;
a plurality of tractive elements, at least one of the plurality of tractive elements driven by the electric motor;
a battery system including a battery pack and a battery management system;
an operator interface; and
a vehicle control system configured to:
acquire a maximum state of charge (SOC) threshold and a reserve SOC threshold for the battery pack;
determine a current SOC of the battery pack;
compare the current SOC of the battery pack to the maximum SOC threshold and the reserve SOC threshold; and
operate one or more components of the recreational vehicle responsive to the current SOC of the battery pack being below the reserve SOC threshold or above the maximum SOC threshold, the one or more components including the electric motor, the battery system, or the operator interface.

2. The recreational electric vehicle system of claim 1, wherein the vehicle control system, responsive to determining the current SOC of the battery pack is above the maximum SOC threshold, is configured to operate the battery management system to signal a power source to stop providing power to the battery pack.

3. The recreational electric vehicle system of claim 1, wherein the vehicle control system is configured to:
operate the operator interface to display a graphical user interface;
receive, from the operator interface, a user input regarding at least one of the reserve SOC threshold or the maximum SOC threshold; and
update at the least one of the reserve SOC threshold or the maximum SOC threshold for the battery pack based on the user input.

4. The recreational electric vehicle system of claim 1, wherein the electric motor is configured to engage in regenerative braking, and wherein the maximum SOC threshold is set to provide a buffer for power generated from the regenerative braking.

5. The recreational electric vehicle system of claim 1, wherein the vehicle control system, responsive to determining the current SOC of the battery pack is below the reserve SOC threshold, is configured to transmit a notification regarding the current SOC of the battery pack to the operator interface.

6. The recreational electric vehicle system of claim 5, wherein the notification instructs an operator to return the recreational vehicle to a return location.

7. The recreational electric vehicle system of claim 6, wherein the reserve SOC threshold is dynamic and based on a current location of the recreational vehicle relative to the return location.

8. The recreational electric vehicle system of claim 6, wherein the vehicle control system is configured to at least partially limit operation of the recreational vehicle in response to the operator not driving towards the return location.

9. The recreational electric vehicle system of claim 5, wherein the reserve SOC threshold is an artificial threshold, and wherein the notification requests operator approval to extend access to capacity of the battery pack.

10. The recreational electric vehicle system of claim 9, wherein the vehicle control system is configured to at least partially limit operation of the recreational vehicle in response to not receiving approval to extend access to the capacity of the battery pack.

11. The recreational electric vehicle system of claim 1, wherein the vehicle control system is configured to:
determine SOC usage trends over a predetermined period of time; and
generate one or more recommendations based on the SOC usage trends.

12. The recreational electric vehicle system of claim 11, wherein the one or more recommendations include at least one of (a) an updated maximum SOC threshold, (b) an updated reserve SOC threshold, or (c) an operational parameter adjustment.

13. The recreational electric vehicle system of claim 11, wherein the vehicle control system is configured to automatically operate the one or more components of the recreational vehicle according to the one or more recommendations.

14. The recreational electric vehicle system of claim 11, wherein the vehicle control system is configured to operate the operator interface to display a notification regarding the one or more recommendations.

15. The recreational electric vehicle system of claim 1, wherein the vehicle control system includes at least one of (a) a first processing circuit located on the recreational vehicle or (b) a second processing circuit located remote from the recreational vehicle.

16. A recreational vehicle system comprising:
one or more processing circuits configured to:
acquire an artificial state of charge (SOC) threshold and a reserve SOC threshold for a battery pack of a recreational vehicle, the artificial SOC threshold and the reserve SOC corresponding to a total SOC of the battery pack;
acquire sensor data indicative of a first SOC of the battery pack;
compare the first SOC of the battery pack to the artificial SOC threshold;
restrict operation of the recreational vehicle responsive to determining that the first SOC is at or below the artificial SOC threshold;
receive a user input to activate a remaining SOC of the battery pack;
permit unrestricted operation of the recreational vehicle in response to the user input;
acquire sensor data indicative of a second SOC of the battery pack;
compare the second SOC of the battery pack to the reserve SOC threshold; and
instruct an operator of the recreational vehicle to return the recreational vehicle to a return location responsive to the determining that the second SOC is at or below the reserve SOC threshold.

17. The recreational vehicle system of claim 16, wherein the one or more processing circuits are configured to acquire a first SOC quantity, wherein the first SOC quantity is a portion of the total SOC of the battery pack.

18. The recreational vehicle system of claim 17, wherein the one or more processing circuits are configured to operate a display device to display the first SOC as a percentage of the first SOC quantity.

19. The recreational vehicle system of claim 17, wherein the one or more processing circuits, responsive to receiving the user input to activate the remaining SOC of the battery pack, is configured to operate a display device to display the second SOC as a percentage of the remaining SOC of the battery pack.

20. A method, comprising:
acquiring an artificial state of charge (SOC) threshold and a reserve SOC threshold for a battery pack of a recreational vehicle, the artificial SOC threshold and the reserve SOC corresponding to a total SOC of the battery pack;
acquiring sensor data indicative of a first SOC of the battery pack;
comparing the first SOC of the battery pack to the artificial SOC threshold;
restricting operation of the recreational vehicle responsive to determining that the first SOC is at or below the artificial SOC threshold;
receiving a user input to activate a remaining SOC of the battery pack;
permitting unrestricted operation of the recreational vehicle in response to the user input;
acquiring sensor data indicative of a second SOC of the battery pack;
comparing the second SOC of the battery pack to the reserve SOC threshold; and
instructing an operator of the recreational vehicle to return the recreational vehicle to a return location responsive to the determining that the second SOC is at or below the reserve SOC threshold.
